(19) United States
(12) Patent Application Publication
(10) Pub. No.: US 2006/0088362 A1
(43) Pub. Date: Apr. 27, 2006

(54) Bottom-fill dispenser for anti-perspirant and gels

(76) Inventors: Matthew Chase, (US); Peter Piscopo, Medford, NJ (US); Alex Szekely, Jackson, NJ (US)

Correspondence Address: BACHMAN & LAPOINTE, P.C., 900 CHAPEL STREET, SUITE 1201, NEW HAVEN, CT, 06510, US

(21) Appl. No.: 11/249,837

(22) Filed: Oct. 12, 2005

Related U.S. Application Data
(60) Provisional application No. 60/618,155, filed on Oct. 12, 2004.

(51) Int. Cl. B43K 5/06

(52) U.S. Cl. 401/172

(57) ABSTRACT

A bottom fill dispenser for solid and gel products includes a dispenser housing, a product platform slidably positioned within the housing, the platform having a product supporting surface and a fill opening passing through the supporting surface; and a plug member positioned within the fill opening. A method is also provided. The dispenser can be used for both gel and solid products, and can be assembled before the filling step.

### CROSS REFERENCE TO PROVISIONAL APPLICATION

This application claims the benefit of the filing date of provisional application Ser. No. 60/618,155, filed Oct. 12, 2004.

### BACKGROUND OF THE INVENTION

The invention relates to dispensers for deodorants such as anti-perspirants and gel products.

Bottom-fill containers are one type of useful dispenser for anti-perspirant products. These containers or packages are typically filled in an upside-down position, with product being poured in from the bottom. Various issues arise when such packages are used. In some instances, assembly must be conducted after the filling of the package. This leads to an extra step, and can also lead to over-pressurization of product within the package that can lead to product breakdown and/or product leakage past the seals in the package.

Anti-perspirant products also typically require a grid or other type of structure to support the dried product. However, such a grid can interfere with proper flow of a gel there through.

Further, other differences between anti-perspirant and gel products frequently lead to the need for different types of packages which can increase the cost of product design and manufacture, as well as increased inventory and like issues.

These and other problems exist in the art.

It is a primary object of the present invention to resolve these issues.

### SUMMARY OF THE INVENTION

In accordance with the present invention, the foregoing objects and advantages have been readily attained.

In accordance with the invention, a package is provided which can advantageously be filled through the bottom, and which has a structure which can advantageously be used when filling with anti-perspirant or with gel products. Further, the package is substantially fully assembled prior to the filling procedure.

According to the invention, a bottom fill dispenser for solid and gel products is provided, and comprises a dispenser housing; a product platform slidably positioned within the housing, the platform having a product supporting surface and a fill opening passing through the supporting surface; and a plug member positioned within the fill opening.

In further accordance with the invention, a method is provided for filling a bottom fill dispenser, which method comprises the steps of providing a dispenser housing; positioning a product platform slidably positioned within the housing, the platform having a product supporting surface and a fill opening passing through the supporting surface; filling product into the housing through the fill opening; and positioning a plug member within the fill opening.

### BRIEF DESCRIPTION OF DRAWINGS

A detailed description of preferred embodiments of the present invention follows, with reference to the attached drawings, wherein:

FIG. 1 is a side sectional view of a package in accordance with the present invention;

FIG. 2 is a rotated side sectional view of the dispenser of FIG. 1;

FIGS. 3a-d are schematic and cross sectional views of a cap for the package of FIG. 1;

FIGS. 4a-e are exterior, sectional and enlarged views of a mesh dome for the package of FIG. 1;

FIGS. 5a-e are exterior, sectional and enlarged views of the barrel of the package of FIG. 1;

FIGS. 6a-d are exterior and sectional views of the elevator assembly of the package of FIG. 1;

FIGS. 7a-d are exterior and sectional views of the platform or product support member which is also illustrated in FIGS. 1 and 6;

FIGS. 8a-d are exterior and sectional views of the threaded member of the package of FIG. 1;

FIGS. 9a and 9b further illustrate the rotatable bottom member of the package of FIG. 1;

FIGS. 10a and 10b illustrate the plug of the package of FIG. 1;

FIGS. 11 and 12 illustrate cross sectional views through a further embodiment of the present invention adapted for use with anti-perspirant product;

FIGS. 13a-d illustrate a removable inner cap member for the package of FIG. 11;

FIGS. 14a-d are exterior and cross sectional views of the barrel member of the embodiment of FIG. 11.

### DETAILED DESCRIPTION

The invention relates to a package for anti-perspirant and gel products. FIG. 1 shows a package 10 in accordance with the present invention. Package 10 as shown in FIG. 1 is readily adapted for use in connection with gel products. As will be discussed further below, with minor variation, this package can also be used for anti-perspirant product.

The key difference between gel and anti-perspirant product is the flow quality of the product during filling and after filling. During filling, anti-perspirant product tends to flow more readily, while gel is more viscous in nature. After filling, anti-perspirant product solidifies and does not need further support, while gel remains in a gel state, and is dispensed through a semi-porous applicator.

The embodiment of this invention as illustrated in FIG. 1 can readily be adapted to use with anti-perspirant in connection with the embodiment which will be discussed further below.

Still referring to FIG. 1, package 10 advantageously includes a barrel or body member 12, an inner cap 14, an outer cap 16 and a product elevator assembly 18 which advantageously includes a platform 20, a threaded member 22, an elevator screw 24 and a plug 26, each of which will be further described below.

Barrel member 12 can be any substantially hollow or open sleeve member, typically substantially elliptical in shape, and having upper and lower ends 28, 30 respectively. Barrel member 12 can advantageously be manufactured of any suitable plastic material which would be well known to a person of ordinary skill in the art. Barrel member 12 defines an inner space for gel or anti-perspirant product, and also houses the components of elevator assembly 18.

Inner cap 14 in connection with the embodiment of FIG. 1 is advantageously a mesh dome-like structure which is adapted to securely fit over the upper end 28 of barrel 12, and which is provided having a plurality of apertures or openings 32 through which gel product seeps when the elevator assembly 18 is manipulated to dispense product.

Inner cap 14 can advantageously have a lower skirt portion 34 adapted to slidably engage with the upper end 28 of barrel 12 as shown. Inner cap 14 can be provided with a peelable seal covering openings 32, and such a seal keeps gel product from passing through openings 32 during filling. In use, the seal is removed and elevator assembly 18 can be used to drive the gel upwardly through openings 32.

Outer cap 16 is advantageously adapted to removably engage with either upper end 28 of package 10 or with inner cap 14. Outer cap 16 advantageously serves to provide a user of package 10 with the means to close package 10 so that product exposed through apertures 32 does not dry out. Outer cap 16 can advantageously engage with either or both of upper end 28 of barrel 12, or inner cap 14, and the embodiment shown in FIG. 1 has outer cap 16 slidably engaging with inner cap 14.

Elevator assembly 18 in this embodiment is advantageously an assembly which allows for product within barrel 12 to be dispensed or disposed toward inner cap 14 and apertures 32 therein so as to dispense a desired amount of product. In this embodiment, elevator assembly 18 includes platform 20 having a product support surface 36, a wiper 38 which in this instance is a double wiper, which is adapted to sufficiently slidably seal against the inner wall of barrel 12, a substantially central opening 40 and a central downwardly depending sleeve 42 which, as illustrated in the drawings, engages with threaded member 22.

Threaded member 22 is advantageously a substantially tubular member sized to fit within downwardly depending sleeve 42 of platform 20, and having an outwardly extending thread 44 adapted to threadedly engage with elevating screw 24. Threaded member 22 is advantageously hollow since, as will be discussed further below, filling of package 10 advantageously takes place by introducing product through the inner space or interior area of threaded member 22.

Elevator screw 24 is also preferably a substantially tubular member, preferably threadedly engaging with threaded member 22 such that rotation of Elevator screw 24 relative to threaded member 22 advances threaded member 22 from lower end 30 toward upper end 28, and back, depending upon direction of rotation of elevator screw 24.

Elevator screw 24 can further advantageously be provided having outwardly extending snap cams 46 which are adapted to snap past and then engage with structure of barrel member 12 so that elevator assembly 18 can be snapped into place.

In the embodiment shown in FIG. 1, barrel member 12 has, at lower end 30 thereof, an inwardly extending web 48 which is adapted to a snap fit and rotatable engagement with elevator screw 24 as desired.

Plug member 26 is advantageously any suitable plug which can be positioned into opening 40 within platform 20, advantageously after product has been introduced into the package to seal the package against back-flow during and after package handling.

The views of FIGS. 3a-d further illustrate outer cap 16 in accordance with the invention. Outer cap 16 can be provided having any desired outer contour, which can preferably be driven by desired appearance of the final package. Outer cap 16 has a bottom edge 162 which defines an opening which is preferably sized to slidably engage the top edge of either barrel member 12 or inner cap 14.

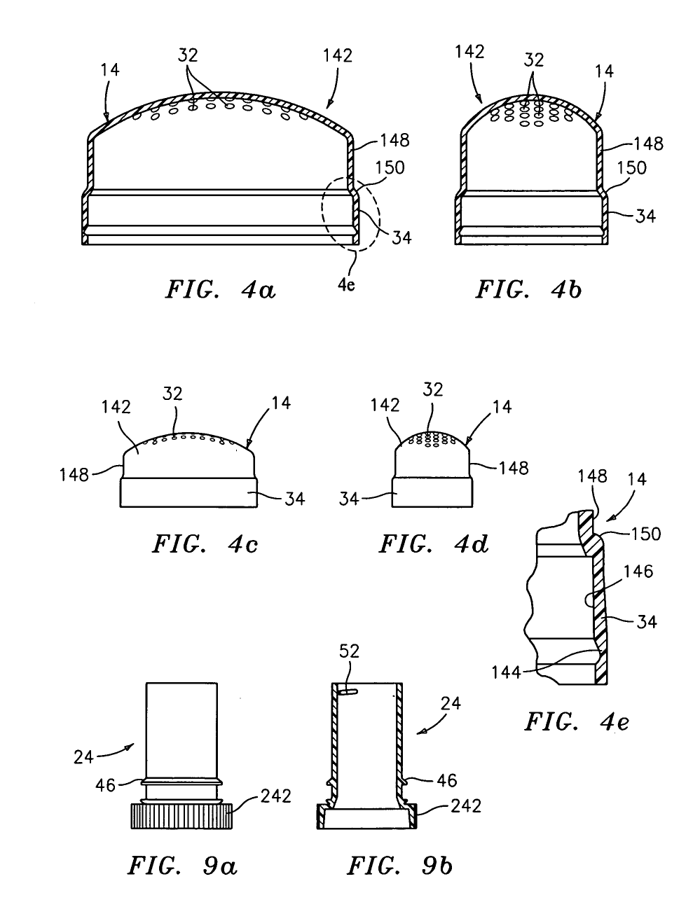

The views of FIGS. 4a-e further illustrate the structure of inner cap 14 in accordance with the present invention, including specific detail of a preferred structure for engaging with barrel member 12.

As shown, inner cap 14 has a dome portion 142 which has perforations 32, or which is otherwise porous to the gel product, as discussed above. Lower skirt portion 34 is preferably sized to engage with the upper edge of barrel member 12. An indentation 144 (FIG. 4e) can advantageously be positioned along an inner surface 146 of skirt portion 34, and is preferably sized to engage with structure on the upper edge of barrel member 12 to hold inner cap 14 in place as desired.

Also as shown, inner cap 14 can be provided having an upper skirt portion 148 which is slightly smaller in diameter than lower skirt portion 34, preferably so that upper skirt portion 148 has substantially the same diameter and contour as the upper edge of barrel member 12. A stepped portion 150 advantageously transitions from upper skirt portion 148 to lower skirt portion 34. This also serves to define an outer surface on inner cap 14 which is suitably sized to receive outer cap 16. Further, in this configuration, the upper portion (at least) of barrel member 12, lower skirt 34 of inner cap 14, and the skirt portion of outer cap 16 can have substantially the same outer contour so as to provide a clean appearance as desired.

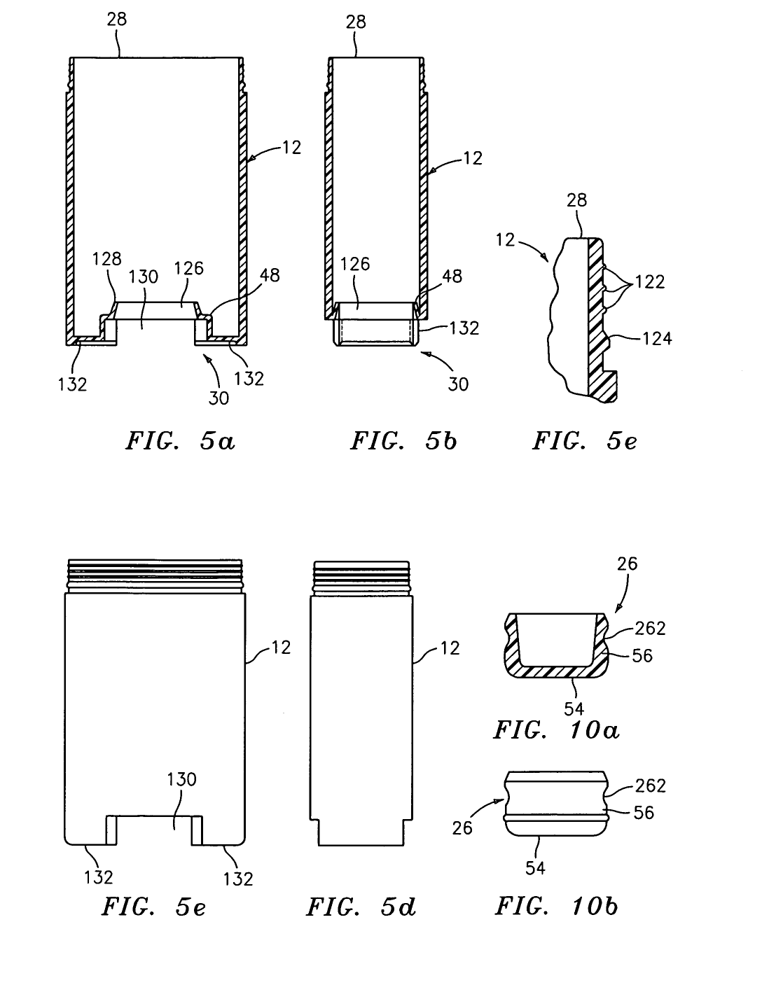

The views of FIG. 5a-e further illustrate the specific structure of barrel 12 of this embodiment, including upper ridges 122 (best shown in FIG. 5e) which are advantageously adapted to securely engage with inner cap 14, and a protruding ridge 124, which may be larger than ridges 122, for engaging indentation 144 of inner cap 14.

Barrel member 12, as shown, has web 48 which extends radially inwardly along bottom edge 30 of barrel member 12 and defines an opening 126 into which elevator assembly 18 is rotatably positioned. A lip 128 of web 48 defines opening 126, and lip 128 of snap cams 46 (best shown in FIG. 1) to rotatably hold elevator assembly 18 within barrel member 12.

Lower end 30 of barrel member 12 preferably has a cutout area 130 positioned to allow external manipulation of the elevating screw 24 as will be discussed below. As shown, wide-spaced ends 132 of lower end 30 extend downwardly to either side of, and define, cutout area 130.

It should be appreciated that web 48 advantageously slopes upwardly and radially inwardly toward lip 128 so as to facilitate proper assembly of elevator assembly 18 into barrel member 12 with snap cams 46 snapped past lip 128. Specifically, the inward slope of web 48 guides snap cams 46 past lip 126 during assembly of elevator assembly into barrel member 12 from the bottom as desired.

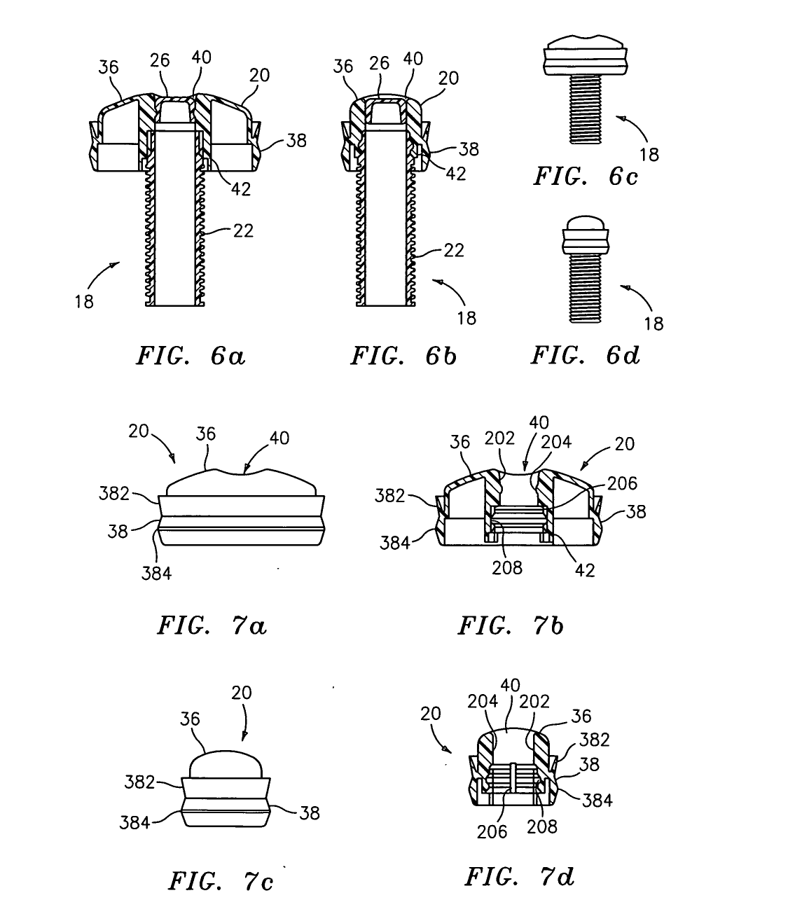

The views of FIGS. 6a-d illustrate elements of elevator assembly 18, advantageously including platform 20, threaded member 22 and plug 26, each of which is further described below.

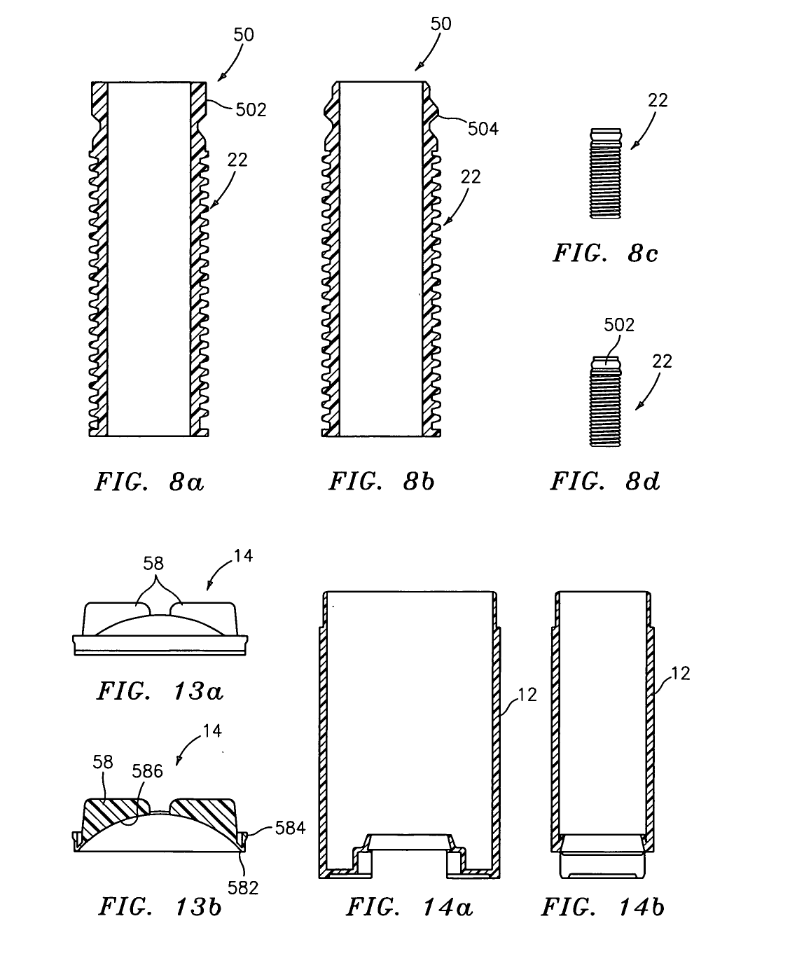

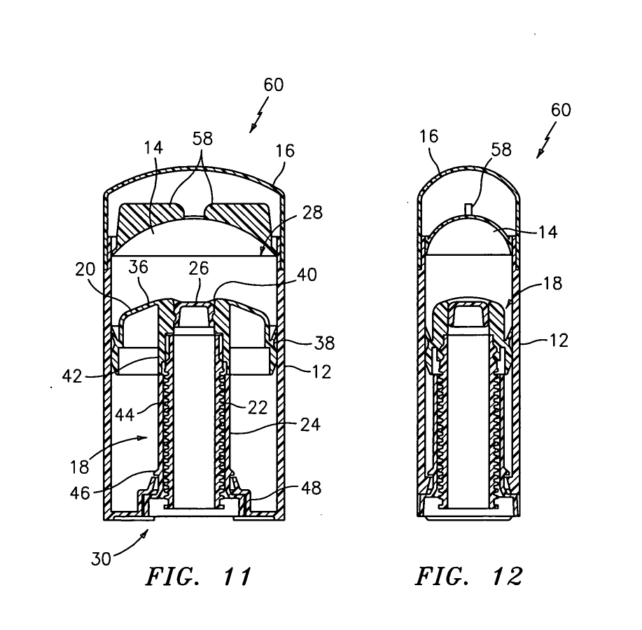

FIGS. 7a-d further illustrate the preferred structure of platform 20. FIGS. 8a-d further illustrate specific preferred structure of threaded member 22 in accordance with the present invention. FIGS. 9a-b further show advantageous details of elevator screw 24.

Referring to FIGS. 7a-d, platform 20 is further illustrated. As shown, opening 40 is preferably defined by inner walls 202 which can be provided with ridges, bumps or other engaging structure 204 to engage with plug 26. Wiper 38 has an upwardly extending skirt 382 and a lower-positioned radial protrusion 384. Axially spaced skirt 382 and protrusion 384 advantageously provide a double-spaced seal against the inner wall of barrel member 12 to prevent leakage past platform 20.

A lower portion of inner walls 202 defines axial slots 206 and radial grooves or ridges 208, and this structure engages with an upper end of threaded member 22 as discussed below.

It should be appreciated that several components of the present invention have interlocking ridges, grooves or bumps. In each of these instances, while the preferred structure is as illustrated and described, any interlocking structure is sufficient and falls well within the broad scope of the present invention.

FIGS. 8a-d show threaded member 22 having an upper end with structure 50 for non-rotatably engaging with platform 20 such that rotation of elevator screw 24 results in relative rotation of screw 24 as compared to threaded member 22, which advances threaded member 22 relative to elevator screw 24 as desired. Structure 50 preferably includes axial ridges 502 for engaging with axial slots 206, and complimentary ridges or grooves 504 for engaging with ridges or grooves 208 of platform 20.

FIGS. 9a-b further illustrate elevator screw 24 and inwardly extending thread 52 which advantageously engages with threads 44 of threaded member 22 such that relative rotation of elevator screw 24 relative to threaded member 22 results in axial displacement of these elements, one relative to the other. Elevator screw 24 also preferably has a knob or wheel 242 positioned thereon to extend radially from cutout area 130 for manual gripping, rotation or other manipulation by a user to operate the elevator assembly and dispense product.

FIGS. 10a-b further illustrate the preferred structure of plug 26, which is advantageously adapted to fit within opening 40 of platform 20 and seal same against back-flow of liquid.

As shown, plug 26 can advantageously have a substantially flat head surface 54 and a sleeve portion 56 which extends from head surface 54, and sleeve portion 56 advantageously has structure which is adapted to securely engage with an opening 40 of platform 20. This structure can be provided as complimentary ridges or grooves 262 positioned to engage with ridges or grooves 204 of platform 20.

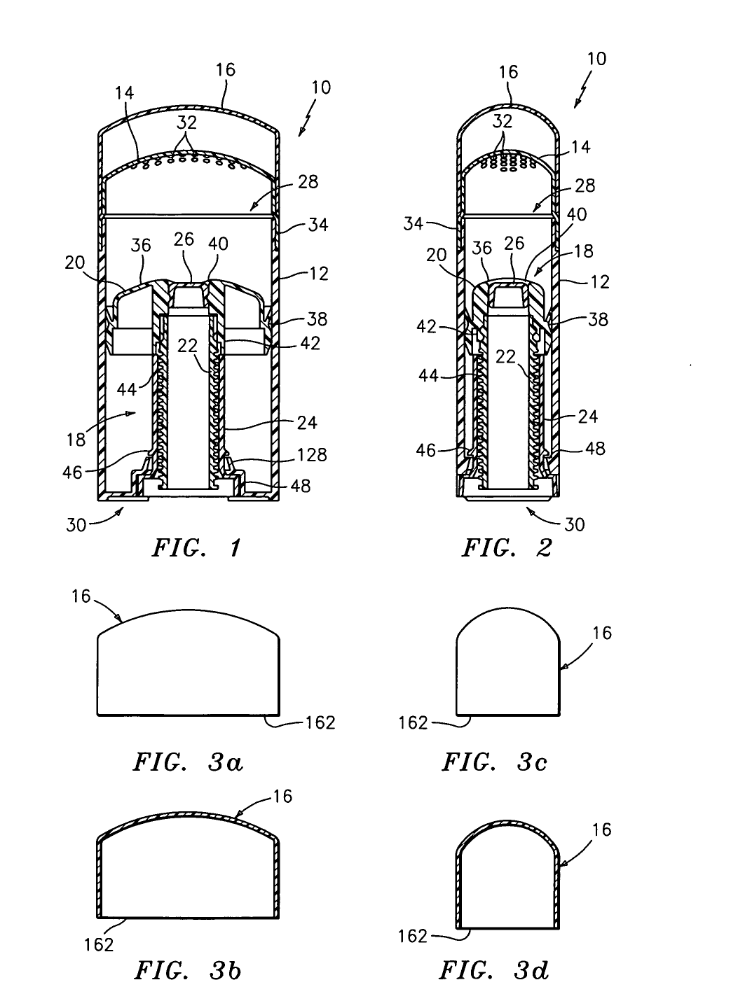

The package of the embodiment of FIGS. 1-10 is advantageously a bottom-fill package adapted for use with a gel product. Specifically, all components of package 10 except for plug 26 are advantageously completely assembled, and package 10 is positioned in an inverted or an upside-down position. In this position, product can be introduced through the opening of threaded member 22 through opening 40 of platform 20 and into the intended product space. Once a desired amount of filling has been conducted, flow stops and package 10 is left in this orientation to allow the gel product to set. At the appropriate time, plug 26 is advanced through threaded member 22 and into opening 40 of platform 20 where it engages with platform 20 to prevent back-flow out of threaded member 22, and the package is now fully loaded and assembled. Depending upon the gel product, the time required to set may be very small. Some gel products will not change significantly in viscosity, and will therefore need a very short, if any, time to set. Other gel products may set somewhat and require or benefit from a short period of time in the inverted position. Plug 26 can be inserted into platform 20 either immediately following filling, or after the setting time, as desired.

Turning to FIG. 11, an embodiment of the present invention is shown which is readily adapted for use with an anti-perspirant product. This package 60 is substantially the same as package 10 of FIG. 1, with the exception being in inner cap 14 and outer cap 16.

Since this product is an anti-perspirant product which sets to a relatively hard product, no mesh dome is needed. Instead, inner cap 14 is advantageously provided as a mold member which serves to form and hold the anti-perspirant product during setting, so that removal of inner cap 14 exposes hardened or solidified product having a shape which matches the inner contour of inner cap 14. Inner cap 14 in this embodiment can advantageously slidably engage with barrel member 12, in this embodiment through slidable engagement with an inner surface of barrel member 12.

Inner cap 14 in this embodiment advantageously has a series of fins 58 positioned thereon, which are readily used for grasping and removing this inner cap 14 before the first use of the package.

FIGS. 13a-b further illustrate inner cap 14 of this embodiment, while FIGS. 14a-b illustrate the structure of barrel member 12 in accordance with this embodiment.

FIGS. 13a and 13b show cap 14 having a lower edge 582 and a skirt 584 extending upwardly from edge 582 to define a sliding surface for mounting inside of the upper edge of barrel member 12. Inner surface 586 of cap 14 serves as a product mold as described above. Mounting of cap 14 in this embodiment in the inside of the upper edge of barrel member 12 allows outer cap 16 to be mounted to the outside of the upper edge of barrel member 12, which desirably allows inner cap 14 to be removed and discarded for the first use of the package, without interfering with the proper positioning of outer cap 16 relative to barrel member 12 for subsequent storage and use.

Barrel member 12 (FIGS. 14a and 14b) of package 60 of the embodiment of FIG. 11 advantageously has upper end 28 with a relatively smooth outer surface since the only cap which is mounted to upper end 28 of barrel member 12 in this embodiment is outer cap 16, which secures with a simple sliding engagement. This is preferred since outer cap 16 is frequently removed by the user during use of the product. The inside surface of the upper end of barrel member 12 can also preferably be substantially smooth, as this allows relatively easy removal of inner cap 14 by the user, when desired.

During filling, package 60 is filled in substantially the same manner as package 10. That is, package 60 is positioned in a substantially inverted or upside-down position, and anti-perspirant product is passed through the inner space of threaded member 22 into the inner space of package 60 as desired. This product flows against the inner surface of inner cap 14, which in this embodiment is a mold, and then sets or forms to the inner contour of inner cap 14.

After package 60 is suitably filled, plug 26 is positioned within opening 40 of platform 20, platform 20 can be advanced into the product if desired, and the package is complete.

It should readily be appreciated that the present invention provides packages which can readily be used with gel and anti-perspirant products, both reliably with a nearly completely assembled package in a bottom-fill operation with minimal leakage and mostly interchangeable parts for use with both gel and anti-perspirant.

It should of course be appreciated that the above description is given in terms of several preferred embodiments of the present invention, each of which is susceptible to modification in shape, size, number of parts and the like. Thus, these examples are to be deemed as examples of the present invention, and are not limiting upon the scope of the present invention, which is defined by the following claims.

We claim:

1. A bottom fill dispenser for solid and gel products, comprising:
a dispenser housing;
a product platform slidably positioned within the housing, the platform having a product supporting surface and a fill opening passing through the supporting surface; and
a plug member positioned within the fill opening.

2. The dispenser of claim 1, further comprising a platform moving assembly engaging the platform and defining a flow passage, the flow passage being aligned with the fill opening of the platform.

3. The dispenser of claim 2, wherein the platform moving assembly comprises a first member engaged with the platform and a second member extending from the housing and rotatably engaged with the first member such that rotation of the second member relative to the first member causes axial movement of the first member and the platform relative to the second member and the housing.

4. The dispenser of claim 3, wherein the first member and the second member are threadedly engaged.

5. The dispenser of claim 3, wherein the first member is non- rotatably engaged relative to the platform.

6. The dispenser of claim 5, wherein the first member comprises one of axial ridges and grooves, and the platform has the other of axial ridges and grooves, and the axial ridges and grooves engage to non-rotatably engage the first member relative to the platform.

7. The dispenser of claim 2, wherein the housing has a top and a bottom, and further comprises an inwardly extending web at the bottom, and wherein the platform moving assembly is rotatably engaged with the web.

8. The dispenser of claim 7, wherein the web defines a substantially circular opening for receiving the second member, and wherein the second member has axially spaced radially extending members which engage both sides of the web and hold the second member rotatably in place relative to the web.

9. The dispenser of claim 2, wherein the platform has a product support surface and a sleeve extending from the platform in a direction away from the product support surface, and wherein the platform moving assembly is engaged with the sleeve.

10. The dispenser of claim 9, wherein the sleeve is aligned with the filling opening.

11. The dispenser of claim 10, wherein the platform moving assembly defines an internal filling flow passage, and wherein the flow passage is aligned with the filling opening.

12. The dispenser of claim 1, wherein the dispenser housing has a top edge, and further comprising a first inner cap disposed over the top edge and having product flow openings therein, and a second outer cap disposed over the first inner cap for sealing the housing.

13. The dispenser of claim 1, wherein the dispenser housing has a top edge, and further comprising a first inner product mold cap disposed over the top edge, and a second outer cap disposed over the first inner product mold cap.

14. The dispenser of claim 1, wherein the dispenser housing has a top edge and further comprises one of a first inner cap disposed over the top edge and having product flow openings therein, and a first inner product mold cap disposed over the top edge; and further comprising a second outer cap adapted to be engaged with either of the first inner cap and the first inner product mold cap.

15. A method for filling a bottom fill dispenser, comprising:
providing a dispenser housing;
positioning a product platform slidably positioned within the housing, the platform having a product supporting surface and a fill opening passing through the supporting surface;
filling product into the housing through the fill opening; and
positioning a plug member within the fill opening.

16. The method of claim 15, wherein the platform further comprises a platform moving assembly extending from the platform and defining a filling passage, and further comprising the step of engaging the platform moving assembly with the housing before the filling step.

17. The method of claim 16, wherein the housing has a top and a bottom, and further comprises an inwardly extending web at the bottom, and wherein the step of engaging the platform moving assembly with the housing comprises engaging the platform moving assembly with the web.

18. The method of claim 17, wherein the web defines a substantially circular opening, and wherein the platform moving assembly has a radially extending member extending beyond a diameter of the circular opening, and wherein the step of engaging the platform moving assembly with the web comprises snapping the radially extending member passed the circular opening.

19. The method of claim 15, wherein the dispenser housing has a top edge, and further comprising the steps of:
positioning a first inner cap over the top edge, the first inner cap having product flow openings therein; and
positioning a second outer cap over the first inner cap for sealing the housing, and wherein the filling step comprises filling the housing with a gel product.

20. The method of claim 15, wherein the dispenser housing has a top edge, and further comprising the steps of:
positioning a first inner product mold cap over the top edge; and
positioning a second outer cap over the first inner product mold cap, and wherein the filling step comprises filling the housing with a solidifying product.
